(19) United States
(12) Patent Application Publication
(10) Pub. No.: US 2026/0138351 A1
(43) Pub. Date: May 21, 2026

(54) EMBOSSING UNIT FOR PROCESSING PAPER WEBS

(71) Applicant: FUTURA S.P.A., Capannori (IT)

(72) Inventors: Fabio PERINI, Viareggio (IT); Gionata MAZZONI, Capannori (IT); Andrea CATALINI, Porcari (IT)

(73) Assignee: FUTURA S.P.A., Capannori, LU (IT)

(21) Appl. No.: 19/121,920

(22) PCT Filed: Dec. 7, 2023
(86) PCT No.: PCT/IT2023/050274

§ 371 Date: Apr. 17, 2025

(30) Foreign Application Priority Data
Dec. 19, 2022 (IT) 102022000025914

(51) Int. Cl. B31F 1/07; B31F 5/04

(52) U.S. Cl. CPC B31F 1/07; B31F 5/04; B31F 2201/0728; B31F 2201/0753; B31F 2201/0787

(57) ABSTRACT

An embossing unit including an engraved steel roller and a rubber counter-roller, where the rubber counter-roller exerts a thrust of a predetermined value on the engraved roller by a corresponding actuator, where the engraved roller a marrying-roll is also associated which exerts on the same engraved roller a radial thrust of a predetermined value by a respective actuator. The thrust exerted by the counter-roller on the engraved roller is contained in a plane passing through the axis of rotation of the respective engraved roller and is inclined by a predetermined angle with respect to a plane passing through the same axis of rotation and also passing through the axis of the marrying-roll, so as to produce a counter-thrust opposite to the thrust. The marrying-roll is made of steel.

The present invention relates to an embossing unit for processing paper webs.

More particularly, the present invention relates to a unit of the type comprising two operating groups, at least one of which comprises an engraved steel roller and a rubber counter-roller which, in cooperation with each other, provide for the embossing of a respective paper ply, while the other operating group can be configured also as an embossing group or as a group for feeding a non-embossed ply. The two plies can be joined together by gluing. The final joining of the plies is favored by the use of a marrying-roll with a rubberized surface which exerts a pressure on the same plies downstream of said operating groups. An operating unit of this type is generally used in so-called paper converting plants in which are produced articles such as toilet paper rolls, kitchen paper rolls and, more generally, products deriving from paper converting.

Disadvantages due to the use of operating units configured in this way derive from the need to exert a considerable pressure with the marrying-roll in order to achieve an effective mutual joining of the plies, which most of the time determines a re-embossing that alters that provided by the two embossing groups and requires excessive energy compared to current production requirements. Furthermore, since the marrying-roll is dragged into rotation by the engraved roller on which it acts, the rotation of the marrying-roll is difficult to be controlled.

US2013/0099417A1 discloses an embossing unit for processing web-like paper materials comprising an embossing roller, a pressure roller coated with an elastically yielding material cooperating with the embossing roller, and at least one actuator that pushes the embossing roller and the pressure roller against each other. In this embossing unit the pressure roller covered with elastically yielding material is structured and controlled in such a way as to allow the paper material to be re-embossed if required by the scheduled production.

The main aim of the present invention is to provide an embossing unit in which it is possible to make use of a marrying-roll which avoids re-embossing of the plies. Another object of the present invention is to provide an embossing unit in which it is possible to reduce the pressure exerted on the paper plies. Yet another object of the present invention is to provide an embossing unit in which the rotation of the marrying roll can be controlled.

This result has been achieved, in accordance with the present invention, by adopting the idea of providing a machine having the features indicated in claim 1. Other features of the present invention are the subject of the dependent claims.

Further advantages and characteristics of the present invention will be more and better understood by every person skilled in the art thanks to the following description and the attached drawings, provided by way of example but not to be considered in a limiting sense, in which:

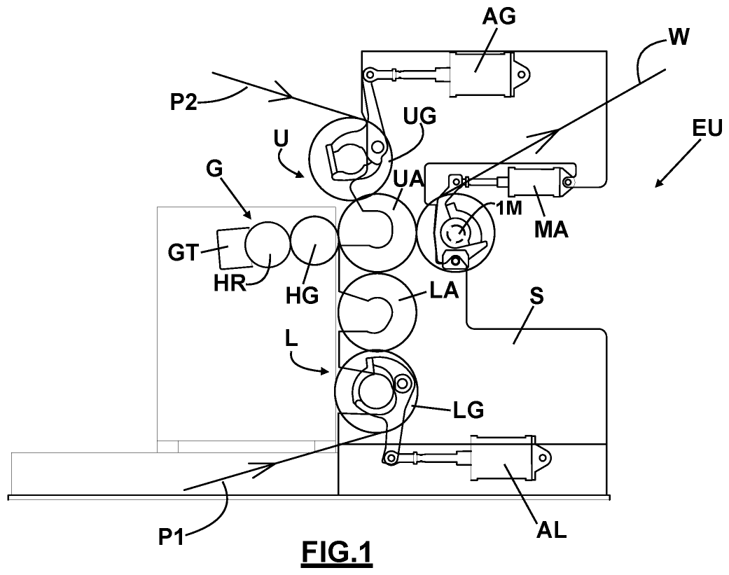

FIG. 1 is a schematic side view of a machine in accordance with the present invention in a possible operating configuration;

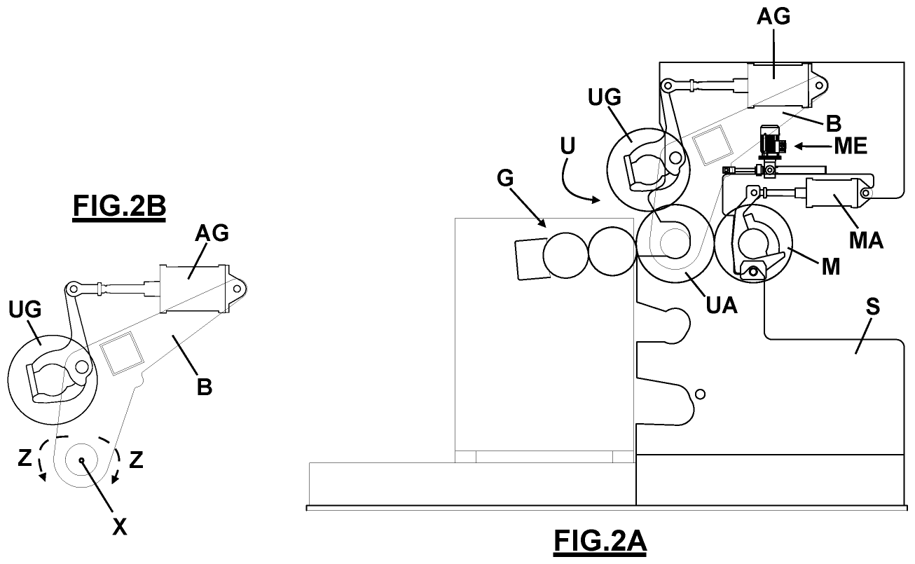

FIG. 2A is also a schematic side view of a machine in accordance with the present invention in which some parts are not represented to better highlight others;

FIG. 2B represents a detail of FIG. 2A;

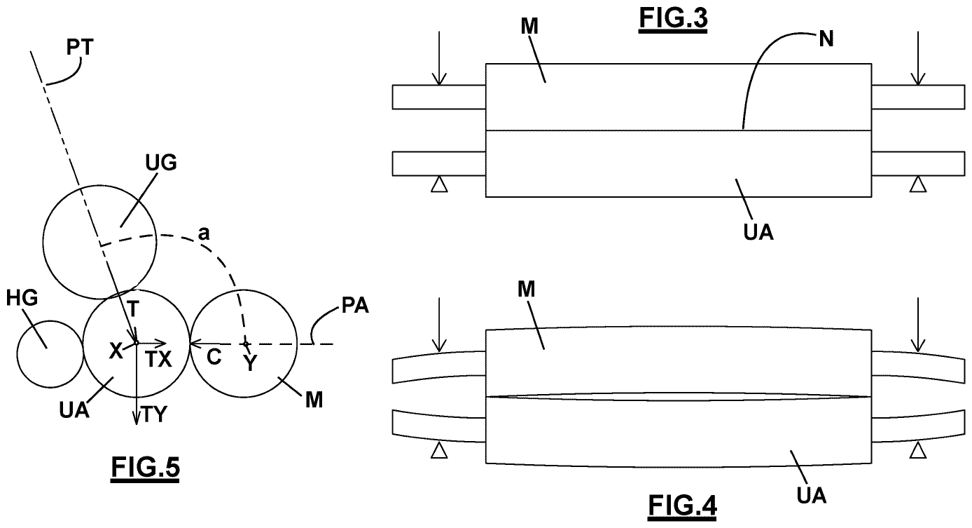

FIG. 3 schematically represents a condition of correct contact between the engraved roller of the second embossing group and the marrying-roll;

FIG. 4 schematically represents a condition of incorrect contact between the engraved roller of the second embossing group and the marrying-roll;

FIG. 5 schematically shows the forces acting at the second embossing group in an embossing unit configured as in FIG. 1;

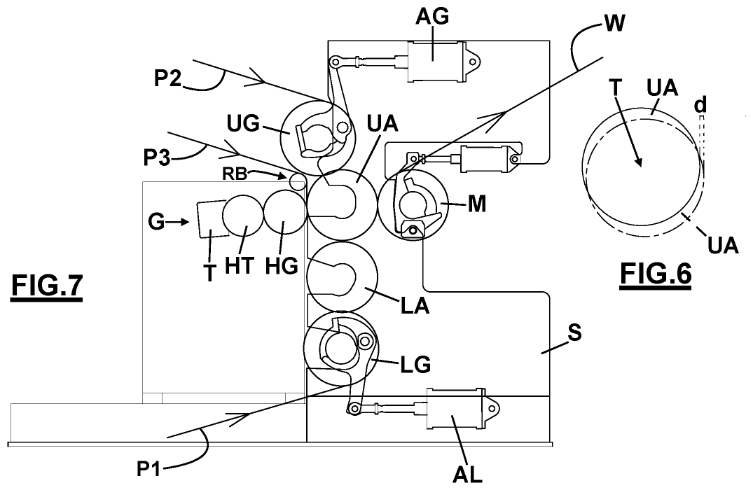

FIG. 6 schematically represents a side view of the undeformed engraved roller (UA), with a solid line, and the deformation resulting from the thrust exerted by the respective counter-roller, with a dotted line;

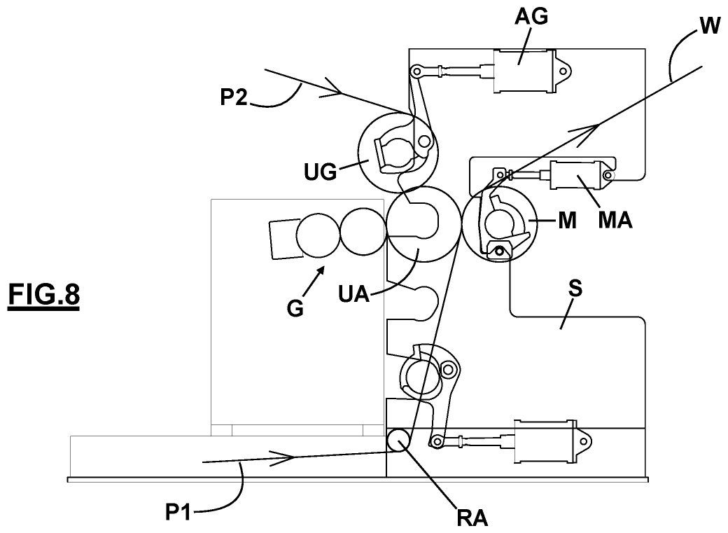

FIGS. 7 and 8 schematically represent two other possible operating configurations of a machine in accordance with the present invention.

Reduced to its essential structure and with reference to the figures of the attached drawings, concerning a possible operative configuration, an embossing unit (EU) in accordance with the present invention comprises for example:
a first embossing group (L);
a second embossing group (U);
a gluing group (G);
a structure(S) configured to support the gluing group (G), the first embossing group (L) and the second embossing group (U).

With reference to the example shown in FIG. 1, the first embossing group (L) is arranged below the second embossing group (U).

Each of said embossing groups (L, U) comprises an engraved steel roller (LA, UA) and a respective rubber counter-roller (LG, UG). Said rollers (LA, LG, UA, UG) are arranged horizontally between two opposing walls of the structure(S). Preferably, the rollers (LA, LG, UA, UG) are removably mounted on the structure(S) by means of removable connection members known per se. For example, the rollers (LA, LG, UA, UG) can be connected to the structure(S) by means of removable or openable collars acting on the ends of the rollers themselves. With reference to the arrangement shown in FIG. 1, the engraved roller (LA) of the first embossing group (L) is above the respective rubber counter-roller (LG) while the engraved roller (UA) of the second embossing group (L) is below the respective rubber counter-roller (UG).

The embossing unit (EU) further comprises a marrying-roll (M) also supported by the structure (S) and oriented with its respective axis parallel to the axes of the rollers (LA, LG, UA, UG). The marrying-roll (M) is in front of the engraved roller (UA) of the second embossing group (U) with respect to the direction followed by the paper plies (P1, P2). The gluing unit (G) is in the opposite position with respect to the marrying-roll (M), i.e. it is behind the engraved roller (UA) of the second embossing group (U). The external surface of the marrying-roll (M) is smooth, i.e. not engraved.

For example, the gluing group (G) comprises a tank (GT) containing glue and a first horizontal roller (HR) which takes the glue from the tank (GT) and transfers it by contact to a second horizontal roller (HG) that, in turn, transfers the glue to a paper ply (P2) as further described below. In a known way, the rollers (HR, HG) of the gluing group rotate with a predetermined speed around the respective axes, controlled by a corresponding electric motor (not visible in the drawings), to withdraw the glue from the tank (GT) and distribute it on the paper ply (P2). Each of the rubber counter-rollers (LG, UG) is pushed against the respective engraved roller (LA, UA) by means of respective actuators (AL, AG) acting on the ends of the same counter-roller.

In the operative mode, the embossing groups (L, U) produce the embossing of the respective plies (P1, P2) with methods known per se: a ply (P1) passes between the rollers (LG, LA) of the first embossing group (L) and another ply (P2) passes between the rollers (UG, LG) of the second embossing group (U). Moreover, the second ply (P2) comes into contact with the second roller (HG) of the gluing unit (G) and both plies (P1, P2) pass between the engraved rollers (LA, UA). Therefore, the plies (P1, P2) are embossed and glued together producing a web of paper material made up of the embossed and glued plies (P1, P2). The web of paper material (W) comes out of the nip formed by the engraved roller (UA) and the marrying-roll (M).

In accordance with the present invention, the rubber counter-roller (UG) of the second embossing group (U) is arranged so as to exert a thrust (T) contained in a plane (PT) passing through the rotation axis (X) of the respective engraved roll (UA) and inclined by a predetermined angle (a) with respect to a plane (PA) passing through the same rotation axis (X) and also passing through the longitudinal axis (Y) of the marrying-roll (M). In practice, with reference to the diagram in FIG. 1, the rubber counter-roller (UG) of the second embossing group (U) is in a backward position with respect to the respective engraved roller (UA) in relation to the direction from which the corresponding web (P2) comes.

The marrying-roll (M) is a steel roller also pushed, by means of respective actuators (AM), towards the engraved roller (UA) of the second embossing group (U). The diagram in FIG. 5 shows the thrust (C) exerted by the marrying-roll (M) on the engraved roller (UA) of the second embossing group (U). The diagram in FIG. 5 also shows the backward position of the counter-roller (UG) with respect to the corresponding engraved roller (UA) and the thrust (T), in addition to the horizontal (TX) and vertical (TY) components of the thrust (T). In the following of this description, said horizontal component will be called counter-thrust. The thrust (C) is of the same order of magnitude as the counter-thrust (TX). In this operating condition, the loads acting on the engraved roller (UA) and on the marry-roll (M) are such as to determine the substantial parallelism of the respective axes and, therefore, the correct contact between the respective surfaces, which define the nip (N) crossed by the web (W). This condition is graphically represented in the diagram of FIG. 3. If, however, the counter-thrust (TX) was not present, due to the deflections suffered by the rollers (M, UA) the contact between the external surfaces of the rollers themselves would be incorrect, as schematized in FIG. 4, such that the intervention of the marrying-roll would be ineffective. Furthermore, the contact between the roller (HG) and the engraved roller of the second embossing group (U) is optimized and it is believed that there may also be advantages in terms of greater energy efficiency of the system. FIG. 6 represents the undeformed engraved roller (UA), with a solid line, and the deformation suffered as a result of the thrust (T) exerted by the respective counter-roller, with a dotted line. The reference “d” represents the radial deflection of the roller (UA).

The marrying-roll (M) can also be a crowned roller if required.

In a machine in accordance with the present invention the following features are synergistically combined:
thrust (T) diagonally oriented, i.e. oriented along the aforementioned plane (PT);
marrying-roll (M) made of steel.

It goes without saying that the previously mentioned planes (PT) and (PA) are geometric planes, not material planes.

The rotation of the marrying-roll (M) is controlled by a corresponding electric actuator (schematically represented in FIG. 1 by the dotted circle 1M).

In an alternative operating configuration, the first operating group (L) can be replaced by a device for feeding the web (P1) which is not embossed. In the example of FIG. 8 this feeding device comprises a roller (RA) that guides the web (P1) into the nip formed by the engraved roller (UA) of the group (U) and the marrying-roll (M).

In another possible operative configuration, as in the schematized example of FIG. 7, in addition to the plies (P1) and (P2) a further ply (P3) is fed with the aid of a roller (RB) that guides the further ply (P3) in the nip between the distribution roller (HG) of the gluing group (G) and the engraved roller (UA). In this case, the machine produces a web (W) comprising the plies (P1), (P2), (P3).

Therefore, a machine in accordance with the present invention can be configured according to a multiplicity of arrangements depending on the features required for the web (W) exiting the machine.

The tank (GT) can contain water instead of glue and possibly ink.

The substances contained in the tank (GT) favor the joining of the plies that form the web (W). The passage of the plies (P1, P2; P1, P2, P3) in the nip formed by the roller (UA) and the marrying-roll (M) determines the definitive joining of the same plies.

The steel marrying-roll (M) avoids the re-embossing of the plies as can instead occur with the use of a rubber-coated marrying-roll which by its nature is elastically yielding. In other words, the greater rigidity of steel compared to rubber, i.e. compared to the elastically yielding materials with which the marrying-rolls of the prior art are covered prevents the linear pressure in the nip formed by the roller (UA) and the marrying-roll (M), typically of an order of magnitude between 12 kg/cm and 25 kg/cm, from producing further embossing of the paper plies.

From the previous description it is evident that an embossing unit (EU) in accordance with the present invention comprises an embossing group (U) for the embossing of a respective ply (P2) to which at least one feeding device for a further ply (P1) is associated, and a group (G) for the distribution of liquids which favor the mutual joining of said plies, wherein the embossing group (U) comprises an engraved steel roller (UA) and a rubber counter-roller (UG), wherein the rubber counter-roller (UG) of the embossing group (U) exerts a thrust (T) of predetermined value on the respective engraved roller (UA) by means of a respective actuator (AG), wherein the engraved roller (UA) of the embossing group (U) is also associated with a marrying-roll (M) which exerts on the same engraved roller (UA) a radial thrust (C) of a predetermined value by means of a respective actuator (MA), and wherein:
the thrust (T) exerted by the counter-roller (UG) of the embossing group (U) on the respective engraved roller (UA) is contained in a plane (PT) passing through the rotation axis (X) of the respective engraved roller (UA) and inclined by a predetermined angle (a) with respect to a plane (PA) passing through the same rotation axis (X) and also passing through the longitudinal axis (Y) of the marrying-roll (M), so as to produce a counter-thrust (TX) oriented along a direction opposite to the radial thrust (C) exerted on it by the marrying-roll (M);
the marrying-roll (M) is made of steel.

From the previous description it is also evident that the device for feeding the further ply can also be configured as an embossing group, although not necessarily.

Preferably, said angle (a) is between 100° and 120°. More preferably, said angle (a) is between 105° and 115° and, even more preferably, between 108° and 112°. In a machine configuration that is considered particularly efficient, said angle (a) is between 109° and 111°. An optimal value of said angle (a) is 110°.

In a possible configuration of the machine described above, the position of the counter-roller (UG) with respect to the engraved roller (UA) can be modified. For example, as represented in the diagram in FIG. 2A, the counter-roller (UG) is mounted on arms (B) hinged on the structure (S) and pivoted on the same axis (X) of the engraved roller (U) and served by an electric jack (ME) which controls its rotation (Z) and, in this way, allows the modification of the aforementioned angle (a). The dotted arrows in FIG. 2B represent said rotation (Z). In FIG. 2A and FIG. 2B only one arm (B) can be seen as they are side views.

The marrying-roll (M) may however have a superficial crowning.

In practice, the execution details can however vary in an equivalent way as regards the individual elements described and illustrated without thereby departing from the scope of the protection offered by this patent in accordance with the attached claims.

1-9. (canceled)

10. An embossing unit comprising: an embossing group for embossing a respective ply to which at least one feeding device for feeding a further ply is associated, and a group for the distribution of liquids which favor the reciprocal union of said plies, wherein the embossing group comprises an engraved steel roller and a rubber counter-roller, wherein the rubber counter-roller of the embossing group exerts a thrust of a predetermined value on the respective engraved roller by a corresponding actuator, wherein, to the engraved roller of the embossing group, a marrying-roll is also associated which exerts on the same engraved roller a radial thrust of a predetermined value by a respective actuator, wherein the thrust exerted by the counter-roller of the embossing group on the respective engraved roller is contained in a plane passing through the axis of rotation of the respective engraved roller and is inclined by a predetermined angle with respect to a plane passing through the same axis of rotation and also passing through the longitudinal axis of the marrying-roll, so as to produce a counter-thrust oriented in the opposite direction in relation to the radial thrust exerted on it by the marrying-roll; and in that the marrying-roll made of steel.

11. The embossing unit according to claim 10, wherein the predetermined angle is between 110° and 120°.

12. The embossing unit according to claim 10, wherein the predetermined angle is between 105° and 115°.

13. The embossing unit according to claim 10, wherein the predetermined angle is between 108° and 112°.

14. The embossing unit according to claim 10, wherein the predetermined angle is between 109° and 111°.

15. The embossing unit according to claim 10, wherein the predetermined angle is equal to 110°.

16. The embossing unit according to claim 10, wherein the predetermined angle is adjustable.

17. The embossing unit according to claim 10, wherein the device for feeding the further ply is also an embossing group.

18. The embossing unit according to claim 10, wherein said counter-thrust and said thrust in modulus are of the same order of magnitude.
